(19) United States
(12) Patent Application Publication
(10) Pub. No.: US 2019/0169908 A1
(43) Pub. Date: Jun. 6, 2019

(54) SAFETY DOOR WITH ULTRASONIC DETECTORS

(71) Applicant: ASSA ABLOY ENTRANCE SYSTEMS AB, LANDSKRONA (SE)

(72) Inventors: Holger SIEWERT, Rheda-Wiedenbruck (DE); Andre ZIMMERMEYER, Rheda-Wiedenbruck (DE); Ercan Cicek, Hovelhof (DE)

(21) Appl. No.: 16/309,997

(22) PCT Filed: Jun. 26, 2017
(86) PCT No.: PCT/EP2017/065614

§ 371 Date: Dec. 14, 2018

(30) Foreign Application Priority Data
Jun. 29, 2016 (SE) 1630167-3

(51) Int. Cl. E05F 15/43; E05F 15/665; E06B 9/08

(52) U.S. Cl. CPC E05F 15/43; E05F 15/665; E05F 2015/763; E05F 2015/433; E06B 9/08

(57) ABSTRACT

The present invention concerns a motorized door having a shutter for closing and opening an area. The door comprises a series of sensors mounted on or adjacent to a leading edge of the shutter and wherein the sensors comprise ultrasonic emitter/receiver units configured for detecting the presence of an obstacle both in the opening plane of the door as well as in an approaching zone located near the opening area of the door. The door comprises a controller configured to distinguish an accidental obstacle from a non-accidental obstacle and instantly stop the movement of the leading edge when an accidental obstacle is observed during closing of the door.

### TECHNICAL FIELD

The present invention relates to a motorized door comprising a shutter for closing and opening an area. More specifically it relates to a motorized door comprising a series of sensors for detecting an accidental obstacle before it is in a position to actually impact with the shutter, and a controller configured for receiving signals from the sensors and for instantly stopping the closing motion of the door when an accidental obstacle is thus detected.

### BACKGROUND OF THE INVENTION

Motorized doors comprising a shutter are commonly used to shut off openings, particularly in warehouses, supermarkets, industrial halls, aircraft hangars, fire service equipment halls, or assembly halls. These shutters are often made up of large flexible tarpaulins the lateral edges of which comprising beads which slide in guiding rails situated on each side of the opening that is to be closed. Alternatively, the shutters can be made of rigid panels hinged to one another side by side or the shutter can be a rigid panel. Automatic doors are particularly useful when they are used to separate two spaces having different environmental conditions, such as temperature, relative humidity and the like, and more particularly to separate an indoor space from outdoor. Doors able to open and close at high speed are also known for these applications and are often referred to as “fast doors”.

One issue with motorized doors, particularly with fast doors due to their high closing speeds, is impacts with obstacles accidentally located within the closing trajectory of the shutter. Besides damaging the leading edge of the shutter and also disengaging the bead of the shutter lateral edges from the guiding rail, the obstacle itself can be damaged. Considering that such obstacle can be a person, the danger in case of an impact of injuring said person is quite high and must be reduced substantially. For this reason, strict norms have been imposed on motorized doors. For example, in order to comply with the European norm EN12453, the peak force of an impact with a body must not exceed the limit of 150 N during more than 5 s, and must not exceed the limit of 400 N during more than 0.75 s.

A number of safety precautions to prevent obstructing objects or persons located in the door opening from being damaged or injured when the door is closing have been proposed and implemented in the art.

Typically, the leading edges of motorized doors are equipped with damping elements, such as a lip made of a resilient material, or pneumatic absorbing pistons. For most doors, in particular fast doors, which have a high kinetic energy, such damping elements reduce the impact force in case of impact, but not sufficiently to meet the requirements of EN12453. Many doors are therefore additionally or alternatively provided with detection cells.

An accidental event detection cell can comprise contact detectors as disclosed for example in US2007/0261305. Alternatively, some detection cells are based on the comparison with a reference value of parameters such as the motor torque, motor energy consumption, or shutter closing speed, such as in U.S. Pat. No. 5,198,974. Such detection cells, however, identify the occurrence of an impact only after the leading edge has contacted the obstacle, which is of limited use for a person being hit by the leading edge of a closing shutter.

Many motorized doors have been developed comprising (a) contactless detection cells suitable for detecting the presence of an obstacle within the closing trajectory of a shutter before an impact occurs, and (b) a control system programmed for implementing a safety function aimed at managing the accidental presence of obstacles, in particular by stopping the door in its travel when it encounters one and moving it away from the obstacle in order to allow the removal thereof. With some control systems, when an accidental presence of an obstacle is detected, the direction of the motion is reversed to re-open the shutter.

Various types of such contactless detection cells are known in the art. For example, U.S. Pat. No. 7,034,686 discloses a proximity detector provided with an antenna, which triggers a command to stop and reverse the closure of the vertical door when the magnetic field created by the antenna is disturbed by a foreign object.

Another type of contactless detection known in the art are comprises the installation of a number of photoelectric barriers across the opening plane of the door as disclosed in U.S. Pat. No. 6,218,940. In this disclosure, the opening plane of the door is provided with what is referred to as a light curtain by means of a scanning light beam. When the light current is infringed, a safety function is activated and the door movement is reversed. A disadvantage of a light curtain is that it only senses obstacles in the plane of the opening of the door. The consequence is that the reversal of the movement of the door does not always take place promptly enough to avoid collision between upwardly projecting parts of the obstacle. For example, the tips of a forklift truck can infringe the light curtain and trigger the reversal of the movement of the door but if the door is not removed fast enough the forklift can still collide with the door.

Detection systems are generally positioned either on the moving shutter, generally at the leading edge of the shutter, or away from the shutter, for example above the proximal transverse edge of the shutter. Positioning a detection system at the leading edge of a moving shutter, such as described in Swedish Patent Application No. SE1551190-0, has the advantage that the relevance of a detected obstacle can be determined as a function of the actual position of the leading edge. For example, if the leading edge of a closing shutter is still close to its opening position, quite far away from a detected obstacle, the detection of said obstacle may not necessarily require the stopping of the shutter. On the other hand, if the obstacle is detected at the last moment when the leading edge is close to said obstacle, in view of the speed and inertia of the closing shutter, an impact may not be avoidable.

When a detection system is positioned away from the moving shutter, its signal is easier to control and analyze since the detection system is static. It can also scan a space ahead of the opening area, so that the relevance of an obstacle can be assessed before it comes within impact distance from the leading edge. Such static detection sensors are, however, disconnected from the instant position of the leading edge, and the detection of an obstacle can trigger the stopping of the shutter when the leading edge is actually at a position which represents no real threat of impact with said obstacle.

There remains a need in the art for a detection system and a control system applied to a motorized door, which can detect accidental obstacles and ensure that an impact can be prevented even when said obstacle reaches the opening area of the door only a very short time before an impact would occur. At the same time, unnecessary stoppings of the shutter movement can also be prevented.

### SUMMARY OF THE INVENTION

The present invention is defined in the appended independent claims. Preferred embodiments are defined in the dependent claims.

In particular, the present invention concerns a motorized door for closing an area, the area being defined by a first and second lateral edges which extend parallel to a longitudinal axis, X1, by a proximal transverse edge extending parallel to a transverse axis, X2, normal to the longitudinal axis, X1, and a distal transverse edge, transverse to the longitudinal axis, X1, and wherein said axis X1 and X2 form a plane (X1, X2). The motorized door according to the invention comprises:
(A) a shutter comprising a first and second main surfaces separated from one another by a thickness of the shutter, and having dimensions suitable for closing the area, and comprising a leading edge substantially parallel to the distal transverse edge of the area,
(B) a motorized driving mechanism suitable for moving the leading edge of the shutter along the longitudinal axis, X1, between an open position (x1,0), wherein the leading edge is adjacent to the proximal transverse edge and a closed position (x1,1), wherein the leading edge contacts the distal transverse edge, in a first direction to close said area and in a second direction to open said area;
(C) a first series of n sensors (3.i, with i=1 to n), wherein n≥2, distributed on the first main surface of the shutter, along the leading edge,
(D) a controller to receive signals from each of the n sensors and configured to instantly stop the movement of the leading edge in the first direction when an accidental obstacle is detected by any one of said sensors,
   where,
each sensor of said first series of n sensors is mounted on the first main surface of the shutter on or adjacent to said leading edge, said sensors being oriented along a central sensor axis forming an opening angle, γ1, with the plane (X1, X2) comprised between 5 and 70°, wherein the opening angle, γ1, is measured on a plane (X1, X3) comprising X1, and normal to the plane (X1, X2),
in that each sensor (3.i) comprises an ultrasonic emitter/receiver unit (8.i), configured for emitting an ultrasonic beam along said central sensor axis, said emitter/receiver unit being suitable for detecting and communicating to said controller, the presence within said ultrasonic beam of an obstacle and the instantaneous distance, di(t), of said obstacle from the corresponding sensor,
   and where, said controller is configured for each sensor to continuously or sequentially:
monitor the instantaneous distance, di(t), of an obstacle to the sensor as the leading edge is moving from said open position (x1,0) to said closed position (x1,1),
continuously or sequentially compare the instantaneous distances, di(t), of said obstacle with a value of a threshold distance, dt(x1), and
instantly stop the movement of the leading edge in the first direction when the instantaneous distance di(t) of an obstacle from said sensor is lower than the threshold distance, dt(x1).

Advantageously, by mounting a sensor with an ultrasonic emitter/receiver unit on the first main surface of the shutter on or adjacent to said leading edge such that the central sensor axis of the sensor forms an opening angle γ1 measured along the plane (X1, X3) comprised between 5 and 70°, preferably between 5 and 40°, more preferably between 10 and 30°, most preferably between 15 and 25°. The maximum detectable distance along the X3 axis to the opening area for detecting an accidental obstacle is decreasing when the door is closing. In this way, when the door is almost closed, any obstacle sufficiently far away from the door (for example a car driving at a given distance from the door) will not disturb the closing of the door. In other words, if during the closing of the door an obstacle is located at a given distance of the opening, whether or not the controller will stop the movement of the closing door will depend on how much the door is already closed. Hence the detectable zone in front of the opening area is varying with the position of the leading edge.

Advantageously, by orienting the sensors at angle γ1 equal or larger than 5°, both obstacles located in the opening area as well as obstacles located further away from the opening area can be detected by the ultrasonic beam. Preferably, γ1 is comprised between 40° and 65°, preferably between 50° and 60°.

Advantageously, by continuously or sequentially monitoring the instantaneous distance, di(t), of any potential obstacle and by continuously or sequentially comparing these instantaneous distances, di(t), with a value of a threshold distance, dt(x1), a distinction can be made between an accidental obstacle and a non-accidental obstacle such as for example the floor or the lateral sides of the area.

In embodiments according to the invention, each ultrasonic emitter/receiver unit has each ultrasonic emitter/receiver unit (8.i) has a first sound pressure half-angle, β1, measured on a plane (X3i, 6.i) defined by the central sensor axis 6.i and an axis X3i parallel to axis X3, passing by the emitter/receiver unit (8.i), which is comprised between 15 and 45°, preferably between 20 and 35°, and wherein β1 is preferably greater than or equal to γ1 (i.e., β1≥γ1).

For example, said opening angle, γ1, and sound pressure half-angle, β1, can be such that,
20°<β1+γ1<90°, preferably 25°<β1+γ1<60° and/or
−30°<β1−γ1<50°, preferably −10°<β1−γ1<40°, more preferably, 0°<β1−γ1<10°.

In other embodiments, the motorized door according to the invention comprises a detector for determining the instantaneous distance, x1(t), of the leading edge to the distal transverse edge and wherein the detector is configured for communicating this instantaneous distance to the controller.

In a preferred embodiment, for each sensor the values of the opening angle, γ1, and of lateral opening angle, γ2, between the central sensor axis and the plane (X1, X2) measured on the plane (X2, X3), can be varied. The lateral opening angle, γ2, can preferably be varied between −45°≤γ2≤45°; said lateral opening angle, γ2, is more preferably comprised within 90°±5°.

The predetermined value of the threshold distance, dt(x1) of the sensors, can preferably be varied as a function of the value of the instantaneous distance, x1(t). For example, dt(x1)<x1(t)+Δx1, wherein Δx1 is the distance between the sensor and the leading edge measured along X1. In another example, dt(x1), decreases with decreasing value of x1(t); it preferably decreases linearly.

In a preferred embodiment of the present invention, the controller is configured for each sensor to continuously or sequentially compare the instantaneous distances, di(t), of said obstacle with a predetermined value of a threshold warning distance, dw(x1)>dt(x1), and to slow down the movement of the leading edge in the first direction and/or to emit a signal selected from a visual and/or acoustic signal, when the instantaneous distance of an obstacle from said sensor is equal to or lower than the threshold warning distance, dw(x1), but larger than the threshold distance, dt(x1), (i.e., when dt(x1)<di(t)≤dw(x1)). Sensors suitable for the present invention are characterized by a maximum detection range MR, which is preferably at least 2 m, more preferably at least 3 m

The controller may further be configured to reverse the movement of the leading edge into the second direction (α2) after having instantly stopped the movement thereof in the first direction (α1).

In embodiments according to the invention, each ultrasonic emitter/receiver unit (8.i) is defined by a second sound pressure half-angle, β2, measured on a plane comprising the central sensor axis (6.i) and an axis X2′(x1) parallel to the axis X2 and intersecting the central sensor axis. The second sound pressure half-angle, β2, is preferably comprised within 25° and 65°.

In preferred embodiments, the motorized door according to the invention comprises a second series of sensors (3.j, with j=1 to m), wherein m≥2, similar to the sensors of the first series and which are distributed on the second main surface of the shutter, along and on or adjacent to the leading edge. The sensors of the second series of sensors have a second opening angle, γ1′, measured on a plane (X1, X3) comprising X1, and normal to the plane (X1, X2). The controller is further configured to receive and treat signals from each of the m sensors of the second series in the same way as it treats the signals from the n sensors of the first series.

### BRIEF DESCRIPTION OF THE FIGURES

For a fuller understanding of the nature of the present invention, reference is made to the following detailed description taken in conjunction with the accompanying drawings in which:

FIG. 1: shows a motorized door according to the present invention, with (a) a front view and (b) a bottom view.

FIG. 2: shows a cross-sectional view in a plane parallel with the X1-X3 plane of an ultrasonic detector mounted on a leading edge of a shutter.

FIG. 3: schematically illustrates a threshold distance dt(x1) and a warning distance dw(x1).

FIG. 4: shows three examples of a value of a threshold distance dt(x1) as function of x1.

FIG. 5: illustrates an example of an ultrasonic beam pattern and illustrates the definition of the sound pressure half-angle β.

FIG. 6: schematically illustrates an ultrasonic beam having a sound pressure half-angle β1 and a sound pressure half angle-β2.

FIG. 7: shows a cross-sectional view of an ultrasonic sensor illustrating the γ1 angle and the definitions of distances L1 and L2.

FIG. 8: shows examples of the distance L1 as function of x1 for different configurations of γ1 and β1.

FIG. 9: shows examples of the distance L2 as function of x1 for different configurations of γ1 and β1.

FIG. 10: shows a cross-sectional view of an embodiment according to the invention comprising a first series of sensors.

FIG. 11: shows a cross-sectional view of an embodiment according to the invention comprising a first series and a second series of sensors.

FIG. 12: shows a cross-sectional view of a second example of an embodiment comprising a first series and a second series of sensors.

FIG. 13: shows a cross-sectional view of a third example of an embodiment comprising a first series and a second series of sensors.

### DETAILED DESCRIPTION OF THE INVENTION

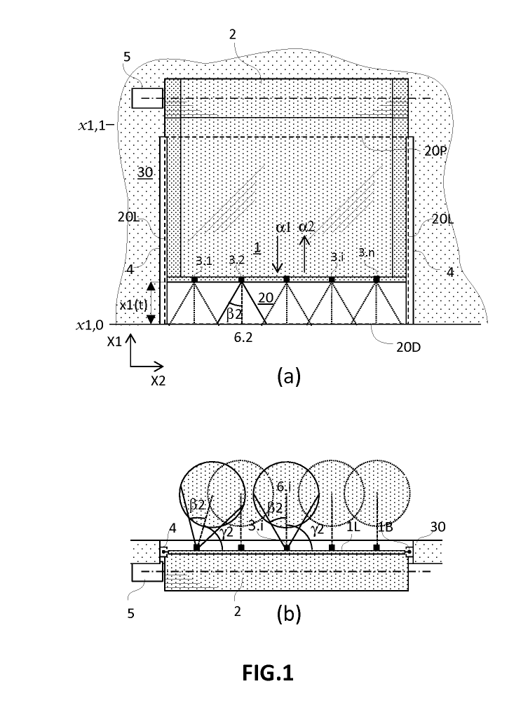

As illustrated in FIG. 1, a motorized door according to the present invention is for closing an opening comprised within a quadrilateral area 20 defined by a first and second lateral edges 20L which extend parallel to a longitudinal axis, X1, by a proximal transverse edge 20P extending parallel to a transverse axis, X2, normal to the longitudinal axis, X1, and a distal transverse edge 20D, transverse to the longitudinal axis, X1. In most cases the distal transverse edge 20D is parallel to the proximal transverse edge 20P and to the transverse axis, X2, but this is not necessarily the case. The area comprises an opening to be closed with a shutter 1 of dimensions suitable for closing the area and the opening comprised therein. Generally, as indicated on FIG. 1, there is a wall 30 surrounding the area.

The shutter comprises a first and second main surfaces separated from one another by a thickness of the shutter. The shutter further comprises a leading edge 1L substantially parallel to the distal transverse edge 20D of the area. The motorized door comprises a motorized driving mechanism 5 suitable for moving the leading edge 1L of the shutter along the longitudinal axis, X1, between an open position, (x1,0), wherein the leading edge is adjacent to the proximal transverse edge and a closed position, (x1,1), wherein the leading edge contacts the distal transverse edge. The leading edge can move in a first direction α1 to close said area and in a second direction α2 to open said area (cf. arrows α1 & α2 in FIG. 1).

The shutter can be a flexible shutter in the form of a flexible fabric or curtain, and, as shown in FIG. 1, the motorized driving mechanism 5 drives for example the rotation of a drum 2 to move the leading edge 1L in the first direction α1 to close the area by unwinding the flexible shutter from the drum, and to move it in the second direction α2 to open the area by winding the flexible shutter about the drum.

In some embodiments, the deformable shutter comprises rigid panels hinged to one another parallel to the transverse axis, X2, and the motorized driving mechanism 5 drives the rotation of an axle about which the hinged panels rotate and change direction. For example, radial pins or teeth in the axle may cooperate with openings within the hinges between panels to ensure a slip-free movement of the deformable shutter. Alternatively, cables or chains can be used to drive the movement of the shutter.

In alternative embodiments, a third type of shutter in the form of a rigid panel is used. In these embodiments, the motorized driving mechanism 5 drives the rotation of an axle which moves the rigid shutter in the plane of the area in the first and second directions.

In case of a vertical area 20 as illustrated in FIG. 1, a shutter is a surface defined by a leading edge 1L moving up and down, the leading edge bridging two lateral edges parallel to one another. Regardless of the type of shutter used, the lateral edges are preferably engaged in guiding rails 4 suitable for guiding the shutter in its trajectory when opening or closing the area 20. An example of an automatic door comprising lateral edges of a shutter coupled to guiding rails is given e.g., in EP0587586 or WO2008155292.

A motorized door according to the present invention comprises a first series of n sensors (3.i, with i=1 to n), wherein n≥2, distributed on the first main surface of the shutter, along the leading edge. The motorized door comprises a controller to receive signals from each of the n sensors and wherein the controller is configured to instantly stop the movement of the leading edge in the first direction α1 when an accidental obstacle is detected by any one of the sensors,

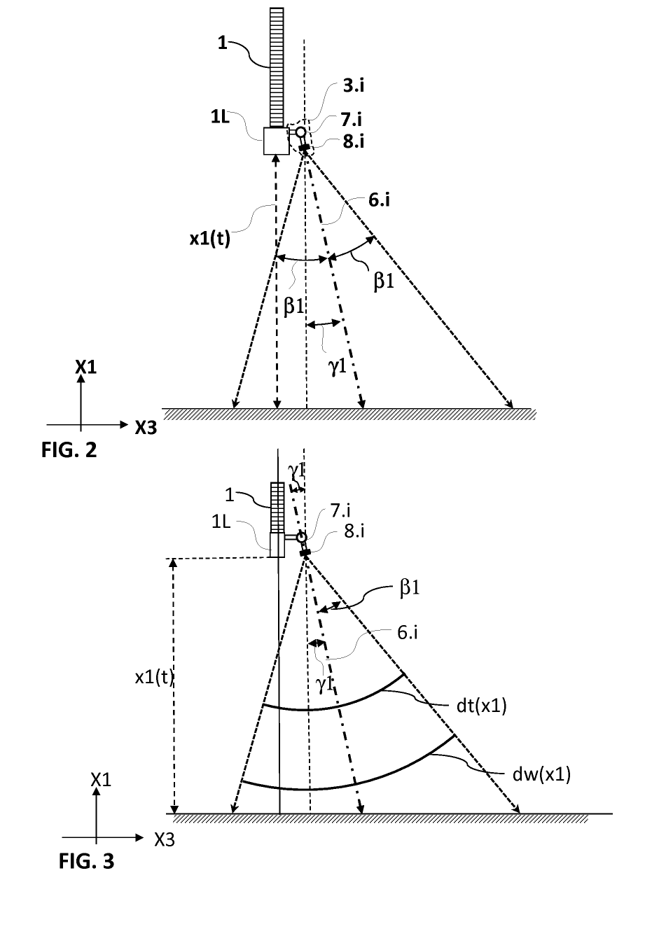

The present invention is characterized in that each sensor 3.i of the first series of n sensors comprises an ultrasonic emitter/receiver unit 8.i configured for emitting an ultrasonic beam along a central sensor axis 6.i. The sensors 3.i are mounted on the first main surface of the shutter on or adjacent to the leading edge 1L and oriented such that the central sensor axis 6.i forms an opening angle, γ1, with the plane (X1, X2) that is comprised between 5 and 70°. This opening angle γ1, as schematically illustrated in FIG. 2, is measured on a plane (X1, X3) defined by X1 and X3, and normal to the plane (X1, X2). Measuring the opening angle γ1 on the (X1,X3) plane has to be construed as making a normal projection of the axis 6.i on the plane (X1,X3) and then measuring the angle between the projected axis 6.i and the plane (X1,X2).

The emitter/receiver unit 8.i is suitable for detecting and communicating to the controller, the presence within the ultrasonic beam of an obstacle and the instantaneous distance, di(t), of the obstacle to the corresponding sensor 3.i.

In some embodiments, the opening angle, γ1, is preferably comprised between 5 and 30°. In other embodiments, as will be illustrated below, γ1 can have a larger value and can be comprised between 40° and 65°, preferably between 50° and 60°.

An ultrasonic emitter/receiver unit 8.i is known to transmit a short burst of ultrasonic soundwave which is reflected by the presence of an obstacle. A controller then measures the time for the echo to return to the sensor and computes the distance from the sensor to the obstacle using the time-of-flight principle and applying the speed of sound in the medium. As the leading edge is moving—often at a high velocity—while the sensors emit and receive ultrasonic waves, the Doppler effect is also taken into account in order to determine the presence of an obstacle and also its possible motion and direction of such motion.

The controller according to the invention is configured to continuously or sequentially perform for each sensor 3.i the following steps:
monitor the instantaneous distance, di(t), of an obstacle to the sensor 3,i as the leading edge is moving from said open position (x1,0) to said closed position (x1,1),
continuously or sequentially compare the instantaneous distances, di(t), of said obstacle with a value of a threshold distance, dt(x1), and
instantly stop the movement of the leading edge in the first direction α1 when the instantaneous distance di(t) of an obstacle from said sensor is lower than the threshold distance, dt(x1).

In some embodiments, after detecting an accidental obstacle, the controller is configured to reverse the movement of the leading edge into the second direction α2 after having instantly stopped the movement thereof in the first direction α1.

The controller can either be a single controller used for all sensors of the series of n sensors or alternatively, each sensor can have its proper controller to control and read-out the signals of the sensor. If a single controller is used, a fast multiplexer can be used to switch between the sensors and control and read-out each sensor in sequence.

Defining a threshold distance is necessary for the controller to be able to distinguish between accidental obstacles and non-accidental obstacles. A non-accidental obstacle is an obstacle which presence at a given position is expected. A typical example of a non-accidental obstacle is the floor which forms the distal transverse edge of a vertical door. Another example is any piece of furniture or piece of architecture which stands in the proximity of the door, but represents no threat to the functioning of the shutter. A non-accidental obstacle will be detected by the sensors, but must be treated by the controller as a non-accidental obstacle. One way of excluding non-accidental obstacles from consideration is to vary the value of the threshold distance, dt(x1), as a function of the value, x1, of the distance of the leading edge to the distal transverse edge. For example, the distance of the floor to the leading edge of a shutter of a vertical door will always be equal to the instant value of x1(t) at any time. One way to exclude the return signal emitted by the floor during the closing of the shutter is to set the value of the threshold distance, dt(x1), as smaller than the value of x1 at any time (dt(x1)<x1(t)). The same applies to any other non-accidental obstacle which may return a signal during the closing of the shutter. In FIG. 3, an example is shown of a value of the threshold distance dt(x1) for a given value of position, x1, of the leading edge. Generally, the threshold distance, dt(x1), decreases with decreasing value of x1(t). In one example, the threshold distance, dt(x1), decreases linearly with the value of x1(t).

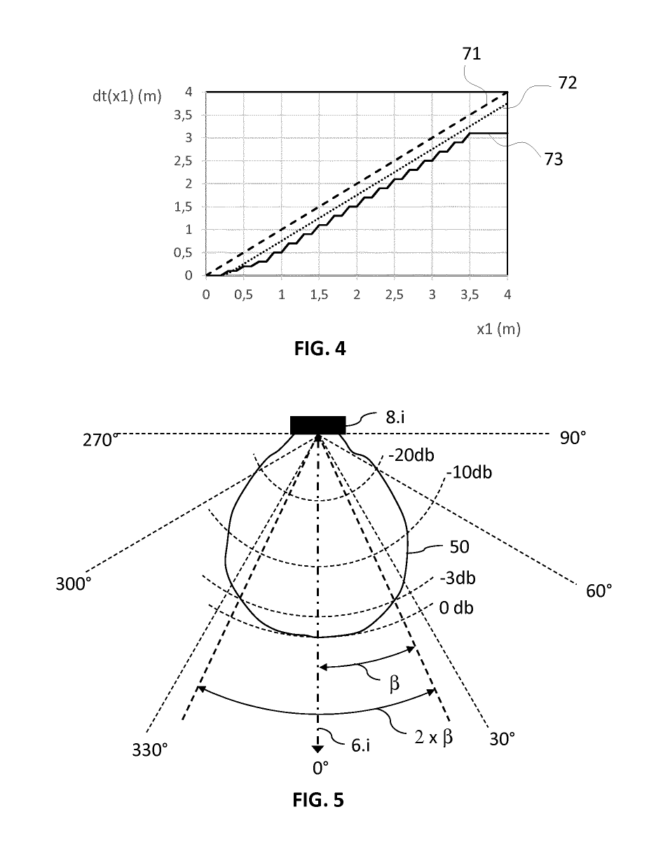

In embodiments, the threshold distance dt(x1) can be a table expressing the threshold distance dt(x1) for a number of values of x1 or dt(x1) can be expressed as a mathematical function. The table or mathematical function can be stored in the memory of the controller In FIG. 4, three examples 71, 72, 73 are shown to illustrate a value of a threshold distance dt(x1) as function of the distance, x1, of the leading edge to the floor. For curve 71, the threshold value is taken to be the instant distance to the floor while for curve 72 a margin of 25 cm is taken in order to take into account uncertainties in the instantaneous distance measurement di(t). The threshold dt(x1) can vary smoothly with the instant position, x1, of the leading edge, as illustrated with curves 71, 72 or it can be a step function as illustrated with curve 73.

As discussed above, the value of the threshold distance, dt(x1) of the sensors, can vary with the value of the instantaneous distance, x1(t). In some embodiments, dt(x1)<x1(t)+Δx1, wherein Δx1 is the distance between the sensor and the leading edge measured along X1.

In alternative embodiments, the instantaneous distances, di(t) of one sensor is compared with the instantaneous distances, di(t) of another sensor. In this case, the value of a threshold distance dt(x1) has to be construed as a value of di(t) measured with another sensor located on the leading edge. As long as two sensors measure the same instantaneous distance di(t), resulting from for example a reflection of the ultrasonic beam by the floor, no accidental obstacle is detected. If however a sensor measures an instantaneous distance di(t) that is lower than an instantaneous distance measured with another sensor, this indicates that an accidental obstacle is detected.

In some embodiments, as illustrated in FIG. 2, each sensor 3.i comprises a sensor supporting device 7.i coupled to the first main surface of the shutter on or adjacent to the leading edge 1L. The supporting device 7.i holds the ultrasonic emitter/receiver unit (8.i) at a fixed position with a given orientation so as to emit an ultrasonic beam in a given direction, 6.i. In some embodiments, the supporting device 7.i comprises for example a rotating element allowing the variation of the orientation of the ultrasonic emitter/receiver unit (8.i) in various emission directions of the ultrasonic beam. In this way, the value of the opening angle γ1 of each sensor 3.i can be varied. In alternative embodiments, the supporting device 7.i is integrated in the leading edge by for example providing an opening to insert the sensors.

As known in the art, the ultrasonic beam emitted by the ultrasonic emitter/receiver unit 8.i has a specific three dimensional radiation or beam pattern. The beam pattern depends on the characteristics of the emitter such as the size and shape of the vibrating surface generating the ultrasonic waves and the frequency of vibration. The sound pressure level is the highest along the central sensor axis 6.i. The sound pressure level along an axis decreases with increasing values of an angle β formed by said axis with the central sensor axis 6.i. An example of a 2D polar plot resulting from a single plane cut through the 3D beam pattern is shown in FIG. 5. In this example shown in FIG. 5, the beam pattern comprises one main lob 50, however in other embodiments the beam pattern may comprise a main lob and a number of side lobs. The sound pressure half-angle β is defined as the angle where the sound pressure of the main lob is reduced by a factor of 2 compared with the sound pressure on the central sensor axis. A reduction of the sound pressure with a factor 2 corresponds to a sound level reduction of −3 dB (decibel). The sound pressure half-angle β is indicated in FIG. 5. Note that the emitter/receiver unit still can have some sensitivity at angles larger than the sound pressure half-angle β but it is strongly reduced and can be suppressed by the controls of the sensor.

As the ultrasonic beam does not necessarily progress along a circular shaped cone but can for example form an elliptical cone, two sound pressure half angles β1 and β2 are generally defined by measuring the sound pressure half-angle β in two orthogonal planes and determining for each plane the sound pressure half-angle with respect to the central sensor axis where the sound pressure is reduced by a factor of 2. Manufacturers of ultrasonic sensors generally provide the values of the characteristic sound pressure half angles β1 and β2. Sometimes, instead of the half-angle β a full angle (=2×β) is specified by the manufacturer. In the present description, a half angle, β, is used.

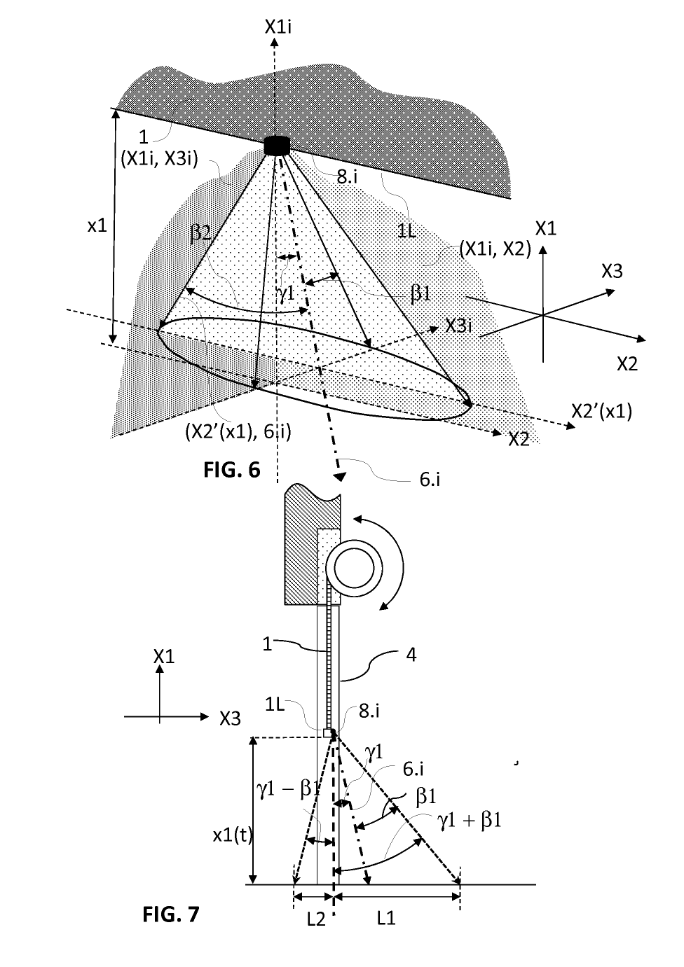

In FIG. 6, an example of an ultrasonic emitter/receiver unit 8.i mounted on a leading edge of a shutter is shown wherein the central axis 6.i is located in a plane (X1i, X3i) formed by axes X1i and X3i passing by the centre of the vibrating surface of the ultrasonic emitter/receiver and being parallel to the axes X1 and X3, respectively. The plane (X1i, X2) is the same as plane (X1, X2) defining the opening area. The centre of the vibrating surface can be considered as the position of the origin or source of the ultrasonic beam. As shown in FIG. 6, there is an opening angle γ1 between the central axis 6.i and the axis X1i, which is set by means of a supporting device 7i (not shown in FIG. 6). The emitted ultrasonic beam expands along a cone defined by a first sound pressure half-angle, β1, measured on a plane (X1i, 6.i) defined by axis 6.i and axis X1i, and which is the same as plane (Xi, X3i) in FIG. 6. But this is not necessarily the case as a central beam axis 6.i can be oriented sideway and define a plane with X1i which is non-normal to the opening plane (X1, X2). As shown in FIG. 6, the emitted ultrasonic beam has a second sound pressure half-angle, β2, measured on a plane (X2′(x1), 6.i) defined by the central beam axis 6.i and an axis X2′(x1) which is parallel to X2 and which position varies with the value of the distance, x1, of the leading edge to the floor.

Typically, the first sound pressure half-angle β1 as measured in the above defined plane (X1i, 6.i) is comprised between 15 and 45°. In preferred embodiments, the sound pressure half-angle, β1, is comprised between 20 and 35°.

In embodiments according to the invention, the sound pressure half-angle, β1, is greater than or equal to γ1 (i.e., β1≥γ1) as shown for example on FIGS. 6&10. In this way, a single sensor can detect accidental obstacles present both ahead of the main surface of the shutter on which it is mounted, referred to as “reference surface”, as well “behind” said reference surface or, in other words, ahead of the other main surface of the shutter. In case the sound pressure half-angle, β1, is equal to γ1 (i.e., β1=γ1), then such ultrasonic sensor would detect any object positioned within its range of detection anywhere ahead of the main surface of the reference surface from the plane of the opening (X1, X2).

The second sound pressure half-angle, β2, measured long plane (X2′(x1), 6.i) is preferably comprised within 25° and 65°. The minimum required value of the second sound pressure half-angle, β2, depends on the number, n, of sensors used for a given door width and the spacing between two sensors. A larger distance between two sensors requires a larger value of angle β2, for preventing any blind spots between the acoustic expansion cones of two adjacent sensors, 8.i and 8.i+1. Generally, the β2 angle value is fixed by the sensor manufacturer and the number of sensors n is then determined by calculation taking into account the width of the door.

The ultrasonic sensors are further characterized by a maximum detection range MR, which is preferably at least 2 m, more preferably at least 3 m. If an obstacle is located at a distance from the sensor that is larger than the specified maximum detection range, it will not be detected. Typically the maximum range of sensors suitable for the present invention is comprised between 2 m and 5 m.

Examples of sensors comprising ultrasonic emitter/receiver units that can be used for the current invention are ultrasonic sensors used in the car industry as parking sensors. For example ultrasonic sensors provided by the company Bosch operate at a frequency of about 48 kHz and have a typical detection range from 20 cm up to 4.5 m. Such sensors have a sound pressure half-angle in a first direction of ±30° (also named vertical opening angle) and sound pressure half angle in a second direction of ±60° (also named horizontal opening angle).

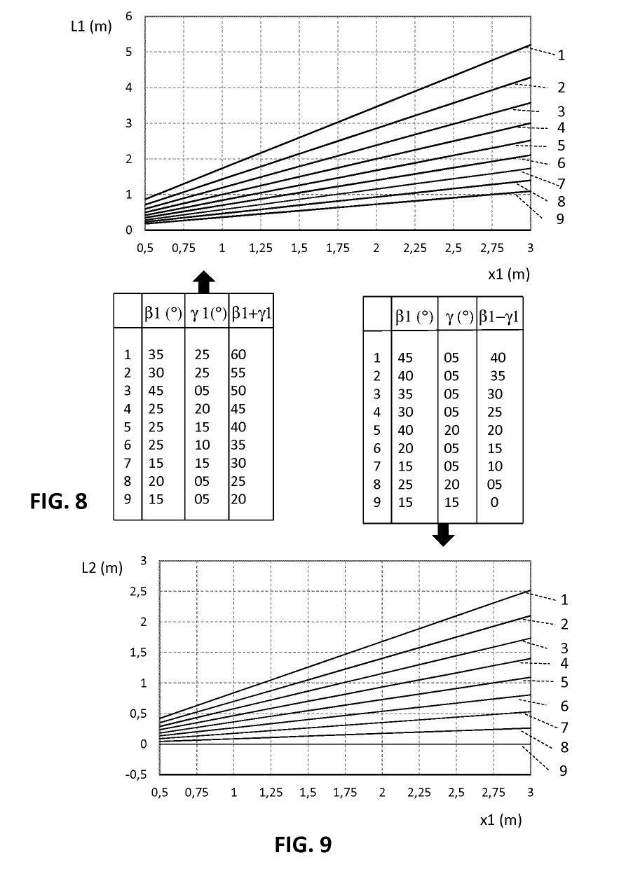

The maximum detection distance, L1, from the area 20, ahead of the reference surface (defined as the main surface of the shutter holding a sensor), and measured along a direction parallel to the axis, X3, for detecting an accidental obstacle depends on the opening angle, γ1, and the sound pressure half-angle, β1. In FIG. 7, a maximum detection distance L1 is measured positively from the axis, X2. The maximum detection distance, L2, is the distance at which a object can be detected “behind” the reference surface. It is measured negatively from the axis, X2. If L2=0, then the sensor only will detect obstacles on one side of the area, the side located ahead of the reference surface. If L2>0, then the sensor will detect obstacles on both sides of the area. The maximum detection distances, L1 and L2, can be determined from the time dependent value of the distance, x1(t), of the leading edge to the floor, and the fixed values of the angles γ1 and β1, simply by using basic trigonometry, so that L1(t)=x1(t) tan(γ1+β1), and L2(t)=x1(t) tan(γ1−β1), wherein L2 is valid only for γ1≤β1. The calculated maximum detection distances, L1 and L2, are represented in FIGS. 8&9, respectively, for a number of values of γ1 and β1. The sum of the angles β1+γ1 define the maximum detection distance, L1 (FIG. 8) while the difference, β1−γ1, defines the maximum detection distance, L2 (FIG. 9).

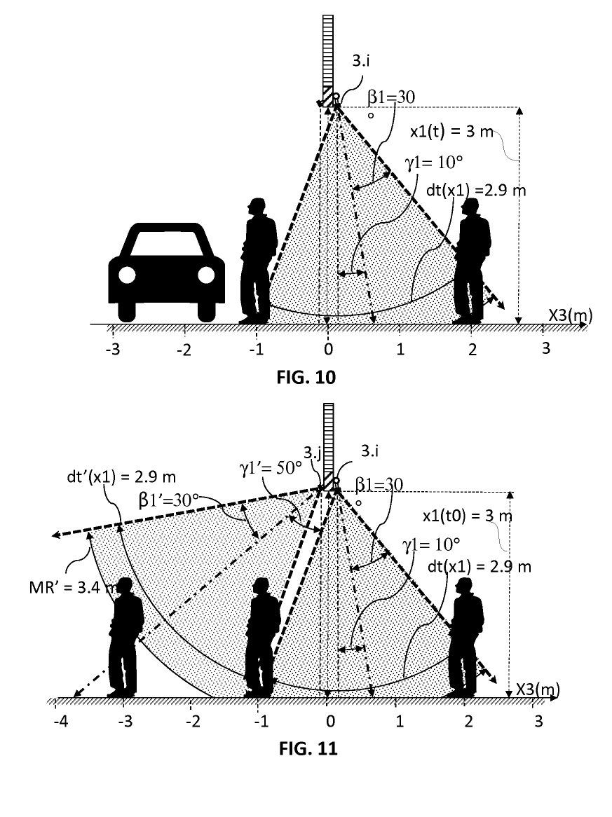

In embodiments according to the invention, 20°<β1+γ1<90° and −30°<β1−γ1<50°. In preferred embodiments, 25°<β1+γ1<60° and −10°<β1−γ1<40°. More preferably, 0°<β1−γ1<10°. FIGS. 10 to 13 illustrate a few examples of configurations of motorized doors according to the invention having various values of (β1+γ1) and (β1−γ1). These examples are further discussed below.

In the embodiment of FIG. 10, a first series of sensors (3.i) is mounted on the first main surface of the shutter adjacent to the leading edge 1L, with values of, γ1=10° and β1=30°. The Figure illustrates the instantaneous position, x1, of the leading edge at a given time, t0. In this example, x1(t0)=3 m. At this instantaneous position x1(t0)=3 m of the leading edge, the threshold value dt(x1) can be set for example at 2.9 m, i.e. any obstacle detected at a distance of up to 2.9 m from the sensor will be interpreted as an accidental obstacle and will trigger the immediate stopping of the movement of the leading edge in the first direction α1. As illustrated in this example, a car located at a distance of about −2 m from the area, on the side of the opening which is opposite the reference surface, will not be detected and will not affect the closing of the door. Only an obstacle, such as for example a person, located closer to the d-surface opposite the reference surface, such as the person standing at about −1 m from the opening, will be detected as an accidental obstacle. The span of the sensor may be symmetrical or asymmetrical with respect to the opening plane (X1, X2). Asymmetrical spans can be useful depending on the direction of the main traffic of moving objects (such as vehicles, robots, etc.) or persons, or the presence of non-accidental obstacles at one side of the opening.

In some embodiments according to the invention, the motorized door further comprises a second series of sensors (3.j, with j=1 to m), wherein m≥2, similar to the sensors of the first series as defined above and which are distributed on the second main surface of the shutter, along and on or adjacent to the leading edge. In FIGS. 11 to 13, the symbols used for defining parameters of the second series of sensor 3.j are the same as those used to refer to corresponding parameters of the first series 3.i, but followed by a prime (′). Each of the sensors of the second series of sensors have a second opening angle, γ1′, measured on a plane (X1, X3) comprising X1, and normal to the plane (X1, X2), and wherein the controller is configured to receive and treat signals from each of the m sensors of the second series in the same way as it treats the signals from the n sensors of the first series. The sensors of the second series also have sound pressure half angles which are referenced as β1′ and β2′.

A FIG. 11 shows a door comprising such second series of sensors 3.j mounted on the second main surface of the shutter adjacent to the leading edge 1L. In this example, the second series of sensors are configured to have γ1′=50° and β1′=30°. In this example, at x1(t0)=3 m, the threshold value dt(x1) for the second series of sensors is set for example to dt(x1)=3 m. The maximum detection range MR is also indicated in the Figure as MR=3.4 m. In this way, with the second series of sensors, a person located at for example +1 m or +2 m from the area will be detected, while a person located at +3 m will not be detected as an accidental obstacle because the distance from the person at +3 m to the sensor is larger than the threshold distance dt(x1) of 3 m. In this way, persons walking at a safe distance of 3 m or more from the area will not affect the closing of the door.

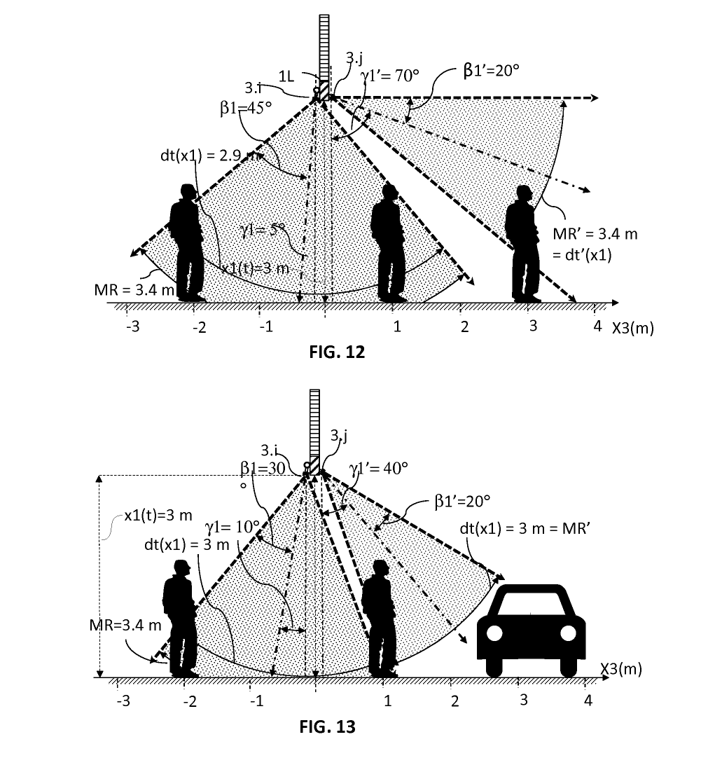

Another example where both a first series and a second series of sensors are mounted on either sides of the leading edge 1L is shown in FIG. 12. In this example, the first series of sensors (3.i) is mounted on the first main surface of the shutter adjacent to the leading edge 1L, wherein γ1=5° and β1=45° and the second series of sensors are configured to have γ1′=70° and β1′=20°. In this example, at x1(t)=3 m, the threshold value dt(x1) for the first series of sensors can be set at for example 2.9 m and for the second series of sensors the threshold value can be set to the maximum detection range of 3.4 m (as, in view of the high value of γ1′ angle, there will be no echo back from the floor). In this way, with the second series of sensors, a person located at +3 m from the area will also be detected. In this example, with the first series of sensors, a person located between for example −2 m and +1 m will also be detected as an accidental obstacle. A person located at +4 m will in this configuration not be detected as an accidental obstacle.

In FIG. 13, another example is given of a first series of sensors with γ1=10° and β1=30° and a second series of sensors with γ1′=40° and β1′=20°. In this example, both series of sensors have a maximum detection range RM of 3 m. When setting the threshold value dt(x1) for the second sensors at for example a value of 3 m, a car located at +3 m will not be detected as an accidental obstacle and hence is not disturbing the closing of the door. Other obstacles like persons located between −2 m and +2 m from the area will be detected by this sensor configuration as an accidental obstacle.

The examples shown in FIGS. 10 to 13 illustrate that many configurations are possible and that the selection of the angles γ1/γ1′ and β1/β1′ depend on the size of the protection zone needed to be covered on either sides of the area.

In embodiments according to the invention, the central axis 6.i of each sensor is generally, as shown in FIG. 6, comprised in a plane parallel with the (X1, X3) plane. In other embodiments as shown in FIG. 1(b), the axis 6.i is not parallel with the (X1, X3) plane and a lateral opening angle γ2 can be defined as the angle between the central sensor axis (6.i) and the plane (X1, X2) measured on a the plane (X2, X3) plane. The lateral opening angle, γ2, is preferably comprised within the range −45°≤γ2≤45°. In some embodiments, the lateral opening angle, γ2, can be varied. The lateral opening angle, γ2, is preferably comprised within the range 90°±5°.

In some embodiments, the motorized door comprises a detector for determining the instantaneous distance, x1(t), of the leading edge (1L) to the distal transverse edge 20D. This detector is configured for communicating this distance to the controller. In this way, based on the received information of x1(t) the corresponding threshold distance dt(x1) can be selected.

In some embodiments, a warning threshold distance dw(x1) is defined with dw(x1)>dt(x1), as illustrated in FIG. 3. The controller is configured for each sensor (3.i) to continuously or sequentially compare the instantaneous distances, di(t), of the obstacle with a predetermined value of the threshold warning distance. When the instantaneous distance of an obstacle from the sensor is equal to or lower than the threshold warning distance dw(x1), the controller will slow down the movement of the leading edge in the first direction and/or emit a signal selected from a visual and/or acoustic signal.

By comparing successive measurements of the distance separating a detected obstacle and the moving leading edge of the shutter, the controller can determine whether such detected obstacle moves towards or away from the moving leading edge. Again the Doppler effect can be used to determine the velocity and direction of displacement of a moving obstacle. The stopping of the shutter may not be triggered in case the detected obstacle does not move towards the leading edge, although it has been detected within the threshold distance, dt(x1), of the sensors.

Unlike the motorized doors of the prior art, a motorized door according to the present invention comprises a detection system which allows:
the detection of accidental obstacles located both within the plane of the opening area, as well as at a given distance from said plane;
the anticipation of an potential impact before it is too late to avoid it,
the free and independent definitions of detection ranges on either sides of a shutter,
the distinction between accidental and non-accidental obstacles, thus limiting non-justified interruption of the closing of a shutter;
the distinction between potentially dangerous and innocuous accidental obstacles detected by the sensors, with respect to the instant position of the leading edge, as well as the moving velocity and direction of such obstacle.

1. A motorized door for closing an area (20), said area being defined by a first and second lateral edges (20L) which extend parallel to a longitudinal axis, X1, by a proximal transverse edge (20P) extending parallel to a transverse axis, X2, normal to the longitudinal axis, X1, and a distal transverse edge (20D), transverse to the longitudinal axis, X1, said axis X1 and X2 form a plane (X1, X2), wherein said motorized door comprises:
A) a shutter (1) comprising a first and second main surfaces separated from one another by a thickness of the shutter, and having dimensions suitable for closing the area, and comprising a leading edge (1L) substantially parallel to the distal transverse edge (20D) of the area,
B) a motorized driving mechanism (5) suitable for moving the leading edge (1L) of the shutter along the longitudinal axis, X1, between an open position, x1,0, wherein the leading edge is adjacent to the proximal transverse edge and a closed position, x1,1, wherein the leading edge contacts the distal transverse edge, in a first direction (α1) to close said area and in a second direction (α2) to open said area;
C) a first series of n sensors (3.i, with i=1 to n), wherein n≥2, distributed on the first main surface of the shutter, along the leading edge,
D) a controller to receive signals from each of the n sensors and configured to instantly stop the movement of the leading edge in the first direction (α1) when an accidental obstacle is detected by any one of said sensors,
characterized in that,
each sensor (3.i) of said first series of n sensors is mounted on the first main surface of the shutter on or adjacent to said leading edge (1L), said sensors (3.i) being oriented along a central sensor axis (6.i) forming an opening angle, □1, with the plane (X1, X2) comprised between 5 and 70°, wherein the opening angle, □1, is measured on a plane (X1, X3) comprising X1, and normal to the plane (X1, X2),
in that each sensor (3.i) comprises an ultrasonic emitter/receiver unit (8.i), configured for emitting an ultrasonic beam along said central sensor axis (6.i), said emitter/receiver unit (8.i) being suitable for detecting and communicating to said controller, the presence within said ultrasonic beam of an obstacle and the instantaneous distance, di(t), of said obstacle from the corresponding sensor (3.i),
and in that, said controller is configured for each sensor (3.i) to continuously or sequentially:
monitor the instantaneous distance, di(t), of an obstacle to the sensor (3,i) as the leading edge is moving from said open position x1,0 to said closed position x1,1,
continuously or sequentially compare the instantaneous distances, di(t), of said obstacle with a value of a threshold distance, dt(x1), and
instantly stop the movement of the leading edge in the first direction (α1) when the instantaneous distance di(t) of an obstacle from said sensor is equal to or lower than the threshold distance, dt(x1).

2. The motorized door according to claim 1, wherein the opening angle, γ1, is comprised between 5 and 40°, preferably between 10 and 30°, more preferably between 15 and 25°.

3. The motorized door according to claim 1, wherein each ultrasonic emitter/receiver unit (8.i) has a first sound pressure half-angle, β1, measured on a plane (X3i, 6.i) defined by the central sensor axis 6.i and an axis X3i parallel to axis X3, passing by the emitter/receiver unit (8.i), which is comprised between 15 and 45°, preferably between 20 and 35°, and wherein β1 is preferably greater than or equal to γ1 (i.e., β1≥γ1).

4. The motorized door according to claim 3, wherein said opening angle, γ1, and sound pressure half-angle, β1, are such that 20°<β1+γ1<90°, preferably 25°<β1+γ1<60° and/or −30°<β1−γ1<50°, preferably −10°<β1−γ1<40°, more preferably, 0°<β1−γ1<10°

5. The motorized door according to claim 1, wherein, γ1 is comprised between 40° and 65°, preferably between 50° and 60°.

6. The motorized door according to claim 1, wherein the value of the opening angle γ1 of each sensor (3.i) can be varied.

7. The motorized door according to claim 1, wherein a value of a lateral opening angle, γ2, between the central sensor axis (6.i) and the plane (X1, X2) measured on the plane (X2, X3), can be varied, wherein said lateral opening angle, γ2, is preferably comprised within the range −45°≤γ2≤45°; and wherein said lateral opening angle, γ2, is more preferably comprised within 90°±5°.

8. The motorized door according to claim 1, comprising a detector for determining the instantaneous distance, x1(t), of the leading edge (1L) to the distal transverse edge (20D) and for communicating it to the controller.

9. The motorized door according to claim 8, wherein the predetermined value of the threshold distance, dt(x1) of the sensors, varies with the value of the instantaneous distance, x1(t) and wherein preferably dt(x1)<x1(t)+Δx1, wherein Δx1 is the distance between the sensor and the leading edge measured along X1.

10. The motorized door according to claim 9, wherein the threshold distance, dt(x1), decreases with decreasing value of x1(t), and preferably decreases linearly.

11. The motorized door according to claim 1, wherein said controller is configured for each sensor (3.i) to continuously or sequentially compare the instantaneous distances, di(t), of said obstacle, with a predetermined value of a threshold warning distance, dw(x1)>dt(x1), and to slow down the movement of the leading edge in the first direction and/or to emit a signal selected from a visual and/or acoustic signal, when the instantaneous distance of an obstacle from said sensor is equal to or lower than the threshold warning distance, dw(x1), but larger than the threshold distance, dt(x1), (i.e., when dt(x1)<di(t)≤dw(x1)).

12. The motorized door according to claim 1, wherein the controller is configured to reverse the movement of the leading edge into the second direction (α2) after having instantly stopped the movement thereof in the first direction (α1).

13. The motorized door according to claim 1, wherein each sensor (3.i) of said first series of n sensors is characterized by a maximum detection range MR, which is preferably at least 2 m, more preferably at least 3 m.

14. The motorized door according to claim 1, wherein each ultrasonic emitter/receiver unit (8.i) is defined by a second sound pressure half-angle, β2, measured on a plane comprising the central sensor axis (6.i) and an axis X2′(x1) parallel to the axis X2 and intersecting the central sensor axis, and wherein β2 is preferably comprised within 25° and 65°.

15. The motorized door according to claim 1, wherein the opening angle, γ1, is between 5 and 40°, further comprising a second series of sensors (3.j, with j=1 to m), wherein m≥2, which are distributed on the second main surface of the shutter, along and on or adjacent to the leading edge, having a second opening angle, γ1′, measured on a plane (X1, X3) comprising X1, and normal to the plane (X1, X2), and wherein the controller is configured to receive and treat signals from each of the m sensors of the second series in the same way as it treats the signals from the n sensors of the first series.
